(19) United States
(12) Patent Application Publication
(10) Pub. No.: US 2016/0309047 A1
(43) Pub. Date: Oct. 20, 2016

(54) IMAGE FORMING APPARATUS FOR DISPLAYING SOFTWARE KEYBOARD

(71) Applicant: KYOCERA Document Solutions Inc., Osaka (JP)

(72) Inventor: Yosuke OKA, Osaka (JP)

(73) Assignee: KYOCERA Document Solutions Inc., Osaka (JP)

(21) Appl. No.: 15/097,797

(22) Filed: Apr. 13, 2016

(30) Foreign Application Priority Data
Apr. 17, 2015 (JP) 2015-085088

(51) Int. Cl. H04N 1/00; G06F 17/22; G06F 3/0488

(52) U.S. Cl. CPC H04N 1/00411; H04N 1/00464; G06F 3/04886; G06F 17/2247; H04N 2201/0094; H04N 2201/3273

(57) ABSTRACT

An image forming apparatus includes an input device; a display device; a keyboard display unit that displays a software keyboard on the display device in response to an operation inputted to the input device with respect to a specific display on the display device; a Web browser that displays on the display device a screen based on a markup document described in a markup language; and an application that, in a markup command to include the specific display in the screen, has the markup document associating the specific display with character string correspondence information corresponding to a character string to be displayed on the software keyboard. When the software keyboard is displayed on the display device, the keyboard display unit performs control so that the character string corresponding to the character string correspondence information associated with the specific display is displayed on the software keyboard.

### INCORPORATION BY REFERENCE

This application is based on and claims the benefit of priority from Japanese Patent Application No. 2015-085088 filed on Apr. 17, 2015, the contents of which are hereby incorporated by reference.

### BACKGROUND

The present disclosure relates to an image forming apparatus in which a software keyboard is displayed on a display device in response to an operation inputted to an input device with respect to a specific display on the display device.

Conventionally, there is known an image forming apparatus in which a software keyboard is displayed on a display device in response to an operation inputted to an input device with respect to a text box being displayed on the display device. In this conventional image forming apparatus, a character string associated with the text box, based on which the software keyboard has been displayed on the display device, is displayed, for example, as a title of the software keyboard.

In the conventional image forming apparatus, in a case where an application is added thereto, when the software keyboard is displayed on the display device in response to an operation inputted to the input device with respect to a text box on a screen of the added application, a character string corresponding to the text box cannot be displayed on the software keyboard.

### SUMMARY

According to a present disclosure, an image forming apparatus includes an input device to which an operation is inputted; a display device that displays information; a keyboard display unit that displays a software keyboard on the display device in response to an operation inputted to the input device with respect to a specific display on the display device; a Web browser that displays on the display device a screen based on a markup document described in a markup language; and an application that, in a markup command to include the specific display in the screen, has the markup document associating the specific display with character string correspondence information corresponding to a character string to be displayed on the software keyboard. In a case where the software keyboard is displayed on the display device in response to an operation inputted to the input device with respect to the specific display, the keyboard display unit performs control so that the character string corresponding to the character string correspondence information associated with the specific display is displayed on the software keyboard.

### BRIEF DESCRIPTION OF THE DRAWINGS

FIG. 1 is a block diagram of an MFP according to one embodiment of the present disclosure.

FIG. 2 is a diagram illustrating one example of a software keyboard that is displayed on a display portion shown in FIG. 1.

FIG. 3 is a diagram illustrating one example of a title table shown in FIG. 1.

FIG. 4 is a diagram illustrating one example of a message table shown in FIG. 1.

FIG. 5 is a diagram illustrating one example of a normal screen that is displayed on the display portion shown in FIG. 1.

FIG. 6 is a sequence diagram of an operation of the MFP shown in FIG. 1 in a case where an application sets a title of the software keyboard and a message in an application control part.

FIG. 7 is a diagram illustrating one example of an application screen that is displayed on the display portion shown in FIG. 1.

FIG. 8 is a diagram illustrating one example of a tag that defines a text box shown in FIG. 7.

FIG. 9 is a sequence diagram of an operation of the MFP shown in FIG. 1 in a case where the software keyboard is opened from the application screen.

FIG. 10 is a diagram illustrating one example of the software keyboard that is displayed on the display portion shown in FIG. 1, which is different from the example shown in FIG. 2.

FIG. 11 is a diagram illustrating one example of a tag that defines the text box shown in FIG. 7, which is different from the example shown in FIG. 8.

### DETAILED DESCRIPTION

The following describes one embodiment of the present disclosure with reference to the appended drawings.

First, a description is given of a configuration of an MFP (multifunction peripheral) as an image forming apparatus according to this embodiment.

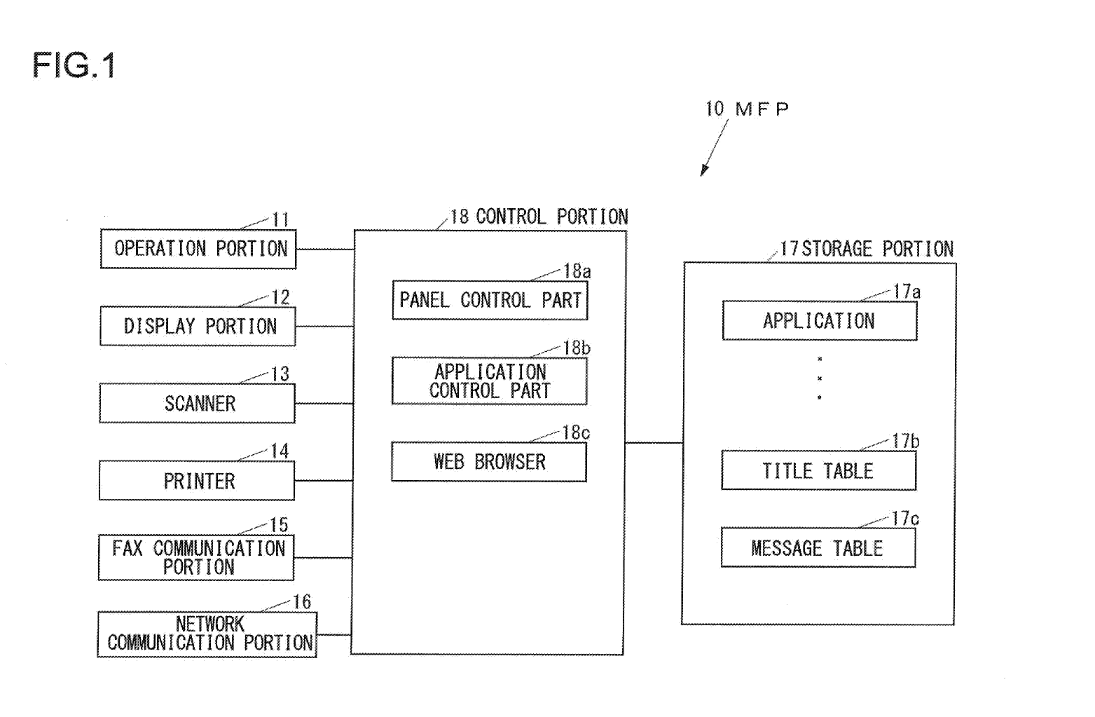

FIG. 1 is a block diagram of an MFP 10 according to this embodiment.

As shown in FIG. 1, the MFP 10 has an operation portion 11 that is an input device such as buttons, to which various operations are inputted, a display portion 12 that is a display device such as an LCD (liquid crystal display), which displays various pieces of information, a scanner 13 that is a reading device which reads an image from an original document, a printer 14 that is a printing device which executes printing on a recording medium such as a paper sheet, a fax communication portion 15 that is a fax device which performs fax communication with an external facsimile device via a communication line such as a public telephone line, a network communication portion 16 that is a network communication device which performs communication with an external device via a network such as a LAN (local area network) or the Internet, a storage portion 17 that is a non-volatile storage device such as an EEPROM (electrically erasable programmable read-only memory, registered trademark) or an HDD (hard disk drive), which stores therein various types of information, and a control portion 18 that controls the entire MFP 10.

At least part of the operation portion 11, together with the display portion 12, may constitute a touch panel.

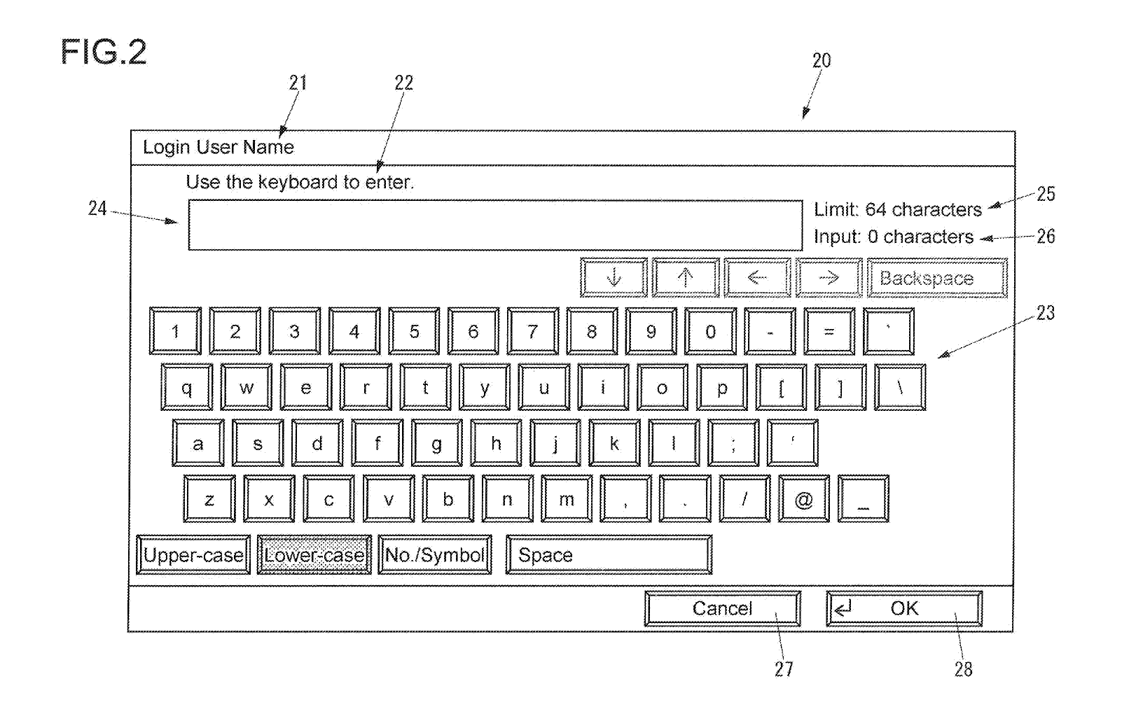

On the display portion 12, a software keyboard 20 as shown in FIG. 2 can be displayed.

FIG. 2 is a diagram illustrating one example of the software keyboard 20 that is displayed on the display portion 12.

As shown in FIG. 2, the software keyboard 20 includes a title region 21 in which a title of the software keyboard 20 is displayed, a message region 22 in which a message for a user is displayed, a keyboard region 23 in which a multitude of keys are arranged, a character string display region 24 in which a character string inputted by using the keys in the keyboard region 23 is displayed, an upper limit display region 25 in which an upper limit of the number of characters of a character string that can be inputted into the character string display region 24 is displayed, a character number display region 26 in which the number of characters of a character string that have been inputted into the character string display region 24 is displayed, a cancel button 27 to cancel an input of a character string made by using the software keyboard 20, and an OK button 28 to confirm an input of a character string made by using the software keyboard 20.

As shown in FIG. 1, the storage portion 17 is capable of storing therein a multitude of applications 17a. Each of the applications 17a may have been installed in the MFP 10 at a manufacturing stage of the MFP 10, may have been additionally installed in the MFP 10 from an external storage medium such as an SD card or a USB (universal serial bus) memory, or may have been additionally installed in the MFP 10 from a network.

The storage portion 17 is capable of storing therein a title table 17b for managing a title to be displayed in the title region 21 of the software keyboard 20 and a message table 17c for managing a message to be displayed in the message region 22 of the software keyboard 20.

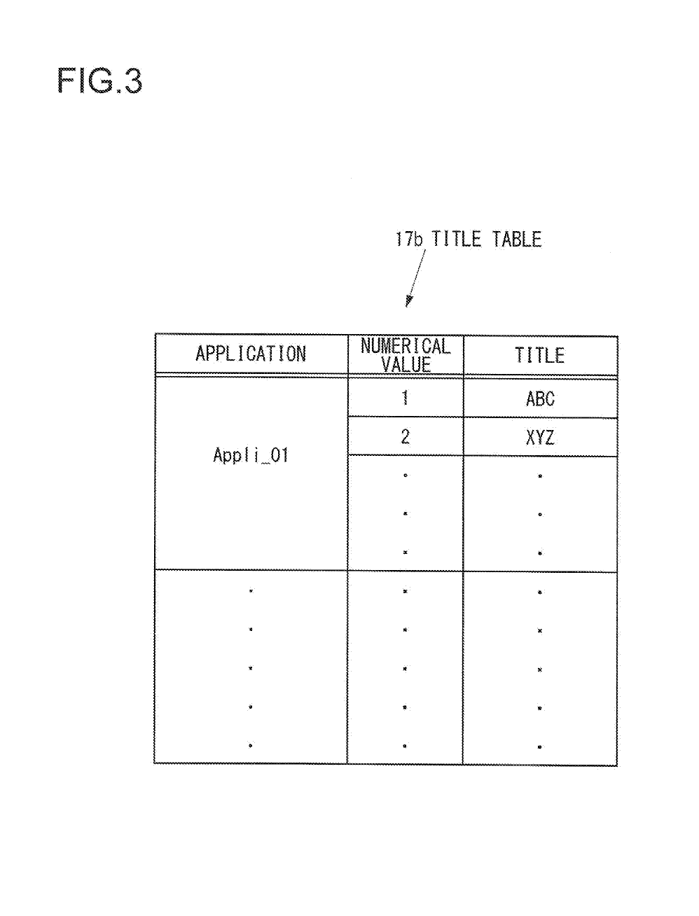

FIG. 3 is a diagram illustrating one example of the title table 17b.

As shown in FIG. 3, the title table 17b stores therein a combination of a numerical value and a title with respect to each of the applications 17a (see FIG. 1).

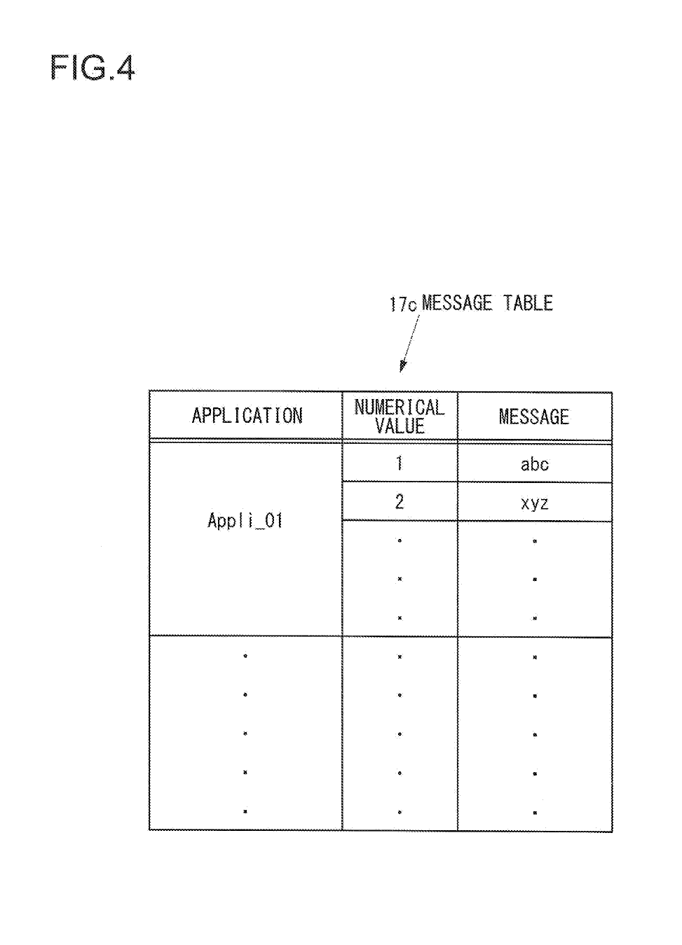

FIG. 4 is a diagram illustrating one example of the message table 17c.

As shown in FIG. 4, the message table 17c stores therein a combination of a numerical value and a message with respect to each of the applications 17a (see FIG. 1).

The control portion 18 shown in FIG. 1 has, for example, a CPU (central processing unit), a ROM (read-only memory) that stores therein a program and various types of data, and a RAM (random access memory) that is used as a work region for the CPU. The CPU executes a program stored in the ROM or the storage portion 17.

By executing the program stored in the ROM or the storage portion 17, the control portion 18 functions as a panel control part 18a for controlling a display on the display portion 12, as an application control part 18b for controlling the applications 17a, and as a Web browser 18c that displays on the display portion 12 a screen based on a markup document described in a markup language.

While the following describes an HTML (hypertext markup language) as an example of the markup language, any other type of markup language than the HTML, such as an XML (extensible markup language), also may be used.

The panel control part 18a is configured so that the software keyboard 20 is displayed on the display portion 12 in response to an operation inputted to the operation portion 11 with respect to a text box as a specific display on the display portion 12, and constitutes a keyboard display unit.

The application control part 18b constitutes part of a platform on which any of the applications 17a is executed. The application control part 18b is configured to manage the title table 17b and the message table 17c, and constitutes a correspondence relationship management unit.

A configuration may be adopted in which the title table 17b and the message table 17c are stored not in the storage portion 17 but in the RAM of the control portion 18.

Next, a description is given of an operation of the MFP 10 (method for displaying a software keyboard).

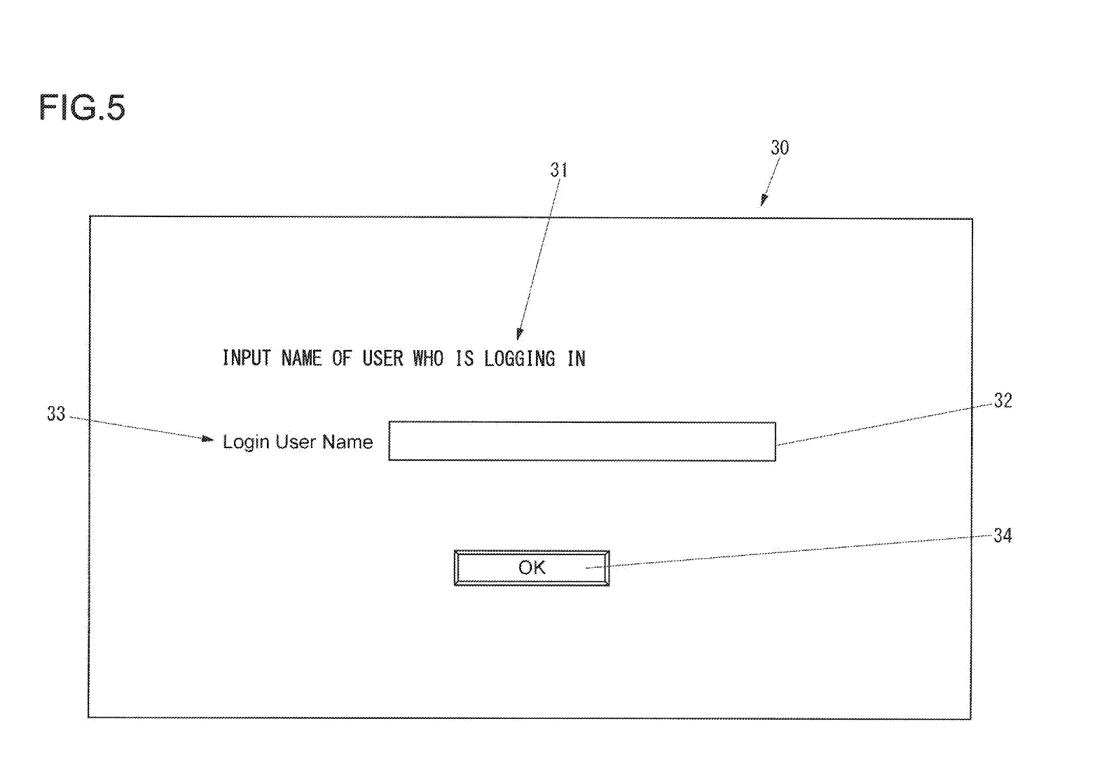

First, the description is directed to an operation of the MFP 10 in a case where the software keyboard 20 is opened from a normal screen 30 (see FIG. 5) irrelevant to the applications 17a.

FIG. 5 is a diagram illustrating one example of the normal screen 30 that is displayed on the display portion 12.

The normal screen 30 shown in FIG. 5 includes a message 31 prompting for an input of the name of a user who is logging in to the MFP 10, a text box 32 for inputting the name of the user who is logging in to the MFP 10, a text 33 that indicates the title of an item to be inputted into the text box 32, namely, the title of an input item in the text box 32, and an OK button 34 for confirming a character string that has been inputted into the text box 32.

Upon the text box 32 being selected through the operation portion 11, the panel control part 18a displays the software keyboard 20 shown in FIG. 2 on the display portion 12, thus accepting an input into the text box 32 being made by using the software keyboard 20. Here, the panel control part 18a displays in the title region 21 of the software keyboard 20 the same character string as the text 33 on the normal screen 30. Furthermore, the panel control part 18a displays a fixed character string in the message region 22 of the software keyboard 20.

Next, a description is given of an operation of the MFP 10 when executing any of the applications 17a.

First, the description is directed to an operation of the MFP 10 in a case where the any of the applications 17a sets a title of the software keyboard 20 and a message in the application control part 18b.

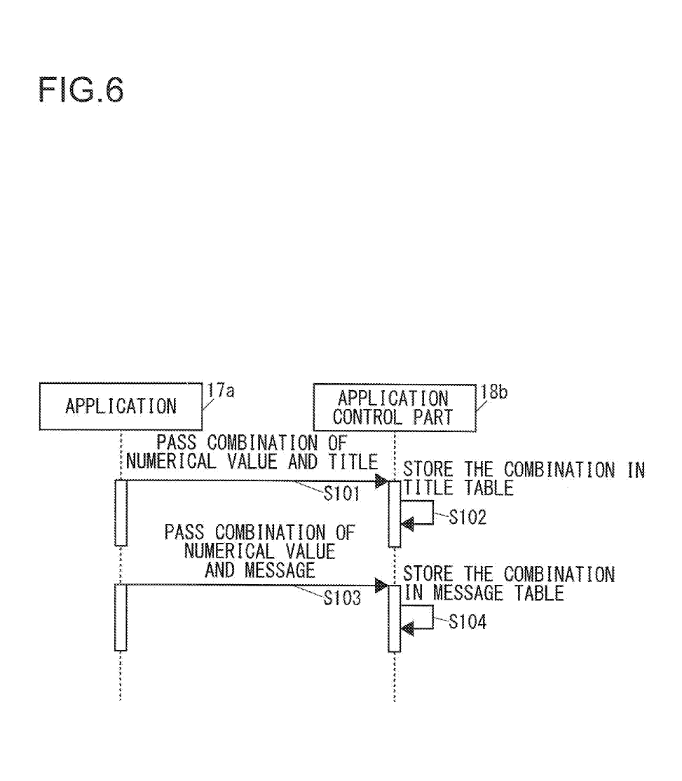

FIG. 6 is a sequence diagram of the operation of the MFP 10 in the case where the any of the applications 17a sets a title of the software keyboard 20 and a message in the application control part 18b.

As shown in FIG. 6, the any of the applications 17a passes a combination of a numerical value and a title to the application control part 18b (S101). Accordingly, the application control part 18b performs control so that identification information of the any of the applications 17a and the combination of a numerical value and a title are stored in the title table 17b (S102).

Next, the any of the applications 17a sets a combination of a numerical value and a message in the application control part 18b (S103). Accordingly, the application control part 18b performs control so that the identification information of the any of the applications 17a and the combination of a numerical value and a message are stored in the message table 17c (S104) to complete the operation shown in FIG. 6.

The any of the applications 17a is only required to execute the operation shown in FIG. 6 before the software keyboard 20 is opened from a screen of the any of the applications 17a itself, namely, an application screen. For example, the any of the applications 17a may execute the operation shown in FIG. 6 immediately after being started up.

A configuration may be adopted in which upon completion of the any of the applications 17a, the application control part 18b deletes data related to the any of the applications 17a, which has just been completed, from the title table 17b and the message table 17c.

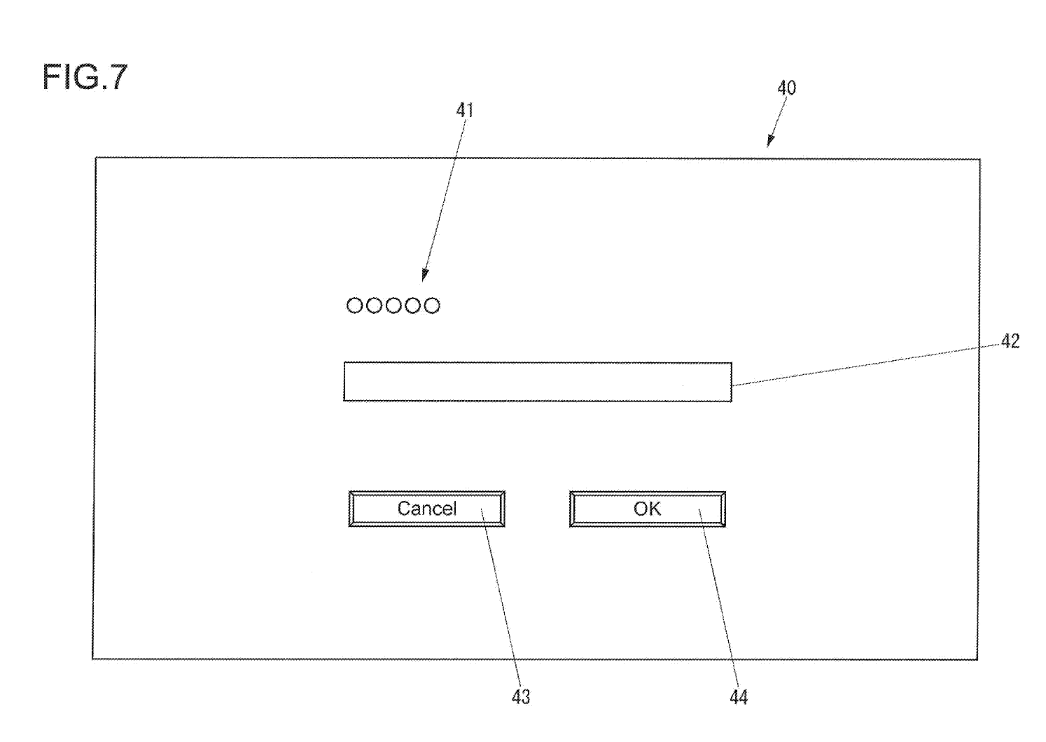

Next, a description is given of an operation of the MFP 10 in a case where the software keyboard 20 is opened from an application screen 40 (see FIG. 7).

FIG. 7 is a diagram illustrating one example of the application screen 40 that is displayed on the display portion 12.

The application screen 40 shown in FIG. 7 includes a message 41, a text box 42, a cancel button 43 to cancel an input of a character string into the text box 42, and an OK button 44 to confirm a character string that has been inputted into the text box 42.

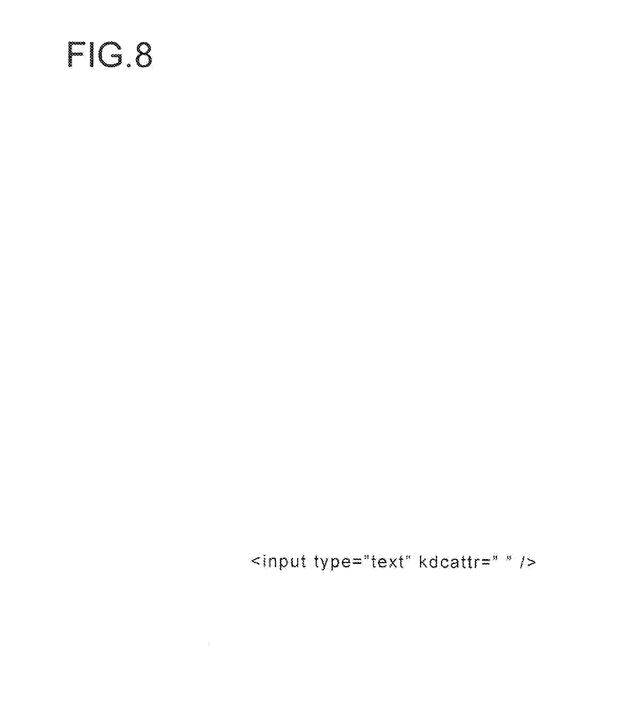

Here, each of the applications 17a (see FIG. 1) has an HTML document including a markup command to include the text box 42 in the application screen 40, namely, a tag shown in FIG. 8. Thus, based on the HTML document provided in the each of the applications 17a, the Web browser 18c is capable of displaying on the display portion 12 the application screen 40 in a state of including the text box 42.

The tag shown in FIG. 8 is associated with unique information “kdcattr” as attribute information indicating an attribute with respect to the text box 42. For “kdcattr”, for example, a value of 32 bits can be set. For example, for 5 bits of the very 1^{st} bit to the 5^{th} bit of the 32 bits of “kdcattr”, a numerical value as character string correspondence information made to correspond to a title to be displayed in the title region 21 of the software keyboard 20 is set. For 5 bits of the 6^{th} bit to the 10^{th} bit from the beginning of the 32 bits of “kdcattr”, a numerical value as character string correspondence information made to correspond to a message to be displayed in the message region 22 of the software keyboard 20 is set. For 1 bit of the 11^{th} bit from the beginning of the 32 bits of “kdcattr”, a value for specifying input character word wrap of characters to be inputted into the text box 42 by using the software keyboard 20 is set.

While the application screen 40 shown in FIG. 7 includes only one text box 42, the application screen 40 may include a plurality of text boxes. Also, values for “kdcattr” set with respect to the plurality of text boxes, respectively, may be different from each other in character string correspondence information.

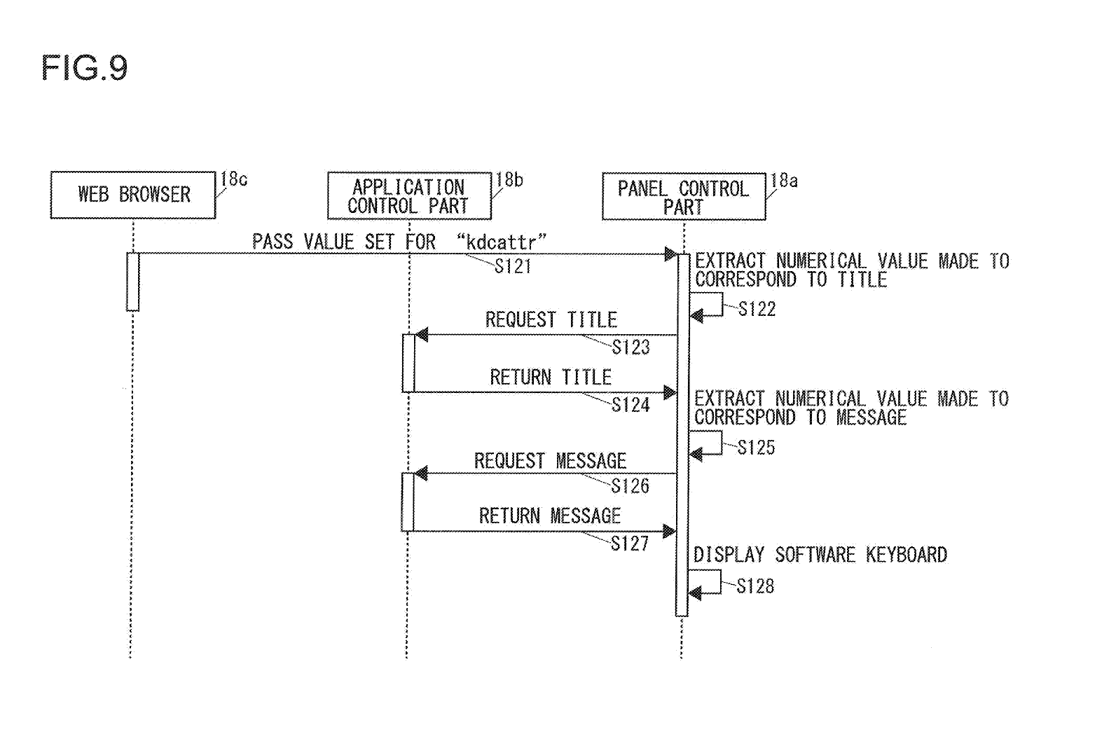

FIG. 9 is a sequence diagram of an operation of the MFP 10 in a case where the software keyboard 20 is opened from the application screen 40.

As shown in FIG. 9, upon the text box 42 on the application screen 40 being selected through the operation portion 11, the Web browser 18c passes values set for “kdcattr” of the tag describing the text box 42 to the panel control part 18a (S121).

Then, the panel control part 18a extracts from the values obtained at S121 a numerical value made to correspond to a title to be displayed in the title region 21 of the software keyboard 20 (S122), and passes to the application control part 18b a combination of identification information of one of the applications 17a which is displaying the application screen 40 and the numerical value extracted at S122, thereby requesting the title from the application control part 18b (S123). Accordingly, the application control part 18b returns to the panel control part 18a one of titles in the title table 17b, which is made to correspond to the combination of identification information of one of the applications 17a and the numerical value passed from the panel control part 18a at S123 (5124).

Furthermore, the panel control part 18a extracts from the values obtained at S121 a numerical value made to correspond to a message to be displayed in the message region 22 of the software keyboard 20 (S125), and passes to the application control part 18b a combination of the identification information of one of the applications 17a which is displaying the application screen 40 and the numerical value extracted at S125, thereby requesting the message from the application control part 18b (S126). Accordingly, the application control part 18b returns to the panel control part 18a one of messages in the message table 17c, which is made to correspond to the combination of the identification information of one of the applications 17a and the numerical value passed from the panel control part 18a at S126 (S127).

Lastly, the panel control part 18a performs control so that the software keyboard 20 is displayed on the display portion 12 (S128). Here, the panel control part 18a performs control so that the one of titles obtained at S124 is displayed in the title region 21 of the software keyboard 20. Furthermore, the panel control part 18a performs control so that the one of messages obtained at S127 is displayed in the message region 22 of the software keyboard 20. Furthermore, the panel control part 18a obtains from the values obtained at S121 a value for specifying input character word wrap of characters to be inputted into the text box 42 by using the software keyboard 20, and applies the input character word wrap corresponding to the value thus obtained to the software keyboard 20.

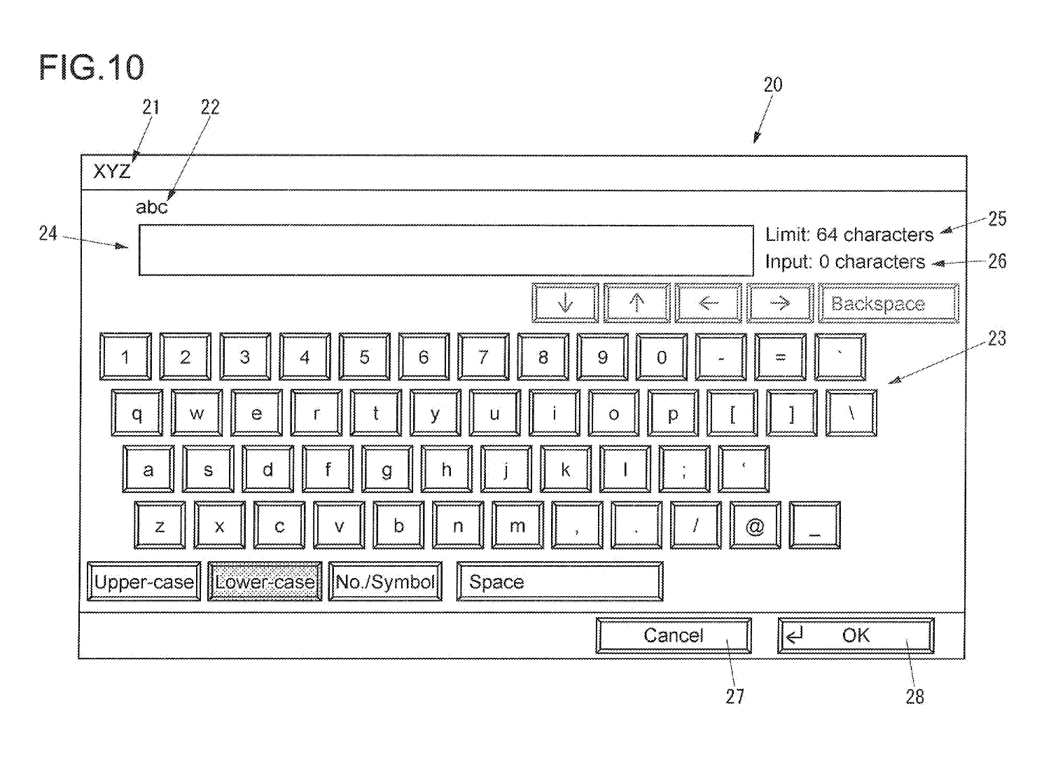

For example, in a case where the application control part 18b manages the title table 17b shown in FIG. 3 and the message table 17c shown in FIG. 4, identification information of one of the applications 17a which is displaying the application screen 40 is “Appli_01”, and among values set for “kdcattr” of the tag describing the text box 42 on the application screen 40, values made to correspond to a title and a message are “2” and “1”, respectively, upon the text box 42 being selected through the operation portion 11, as shown in FIG. 10, the MFP 10 displays on the display portion 12 the software keyboard 20 in a state where “XYZ” is set in the title region 21 and “abc” is set in the message region 22.

As has been described thus far, in the MFP 10, in the tag for including the text box 42 in the application screen 40, each of the applications 17a has an HTML document associating the text box 42 with character string correspondence information, and in a case where the software keyboard 20 is displayed on the display portion 12 in response to an operation inputted to the operation portion 11 with respect to the text box 42, a character string corresponding to the character string correspondence information associated with the text box 42 is displayed on the software keyboard 20. Thus, in a case where the software keyboard 20 is displayed on the display portion 12 in response to an operation inputted to the operation portion 11 with respect to the text box 42 on the application screen 40 of an added one of the applications 17a, a character string corresponding to the text box 42 can be displayed on the software keyboard 20.

The MFP 10 is capable of freely controlling a title of the software keyboard 20 and a message on an application 17a side, and thus improved convenience can be provided.

In the MFP 10, a character string to be displayed on the software keyboard 20 is made to correspond not only to character string correspondence information but also to any of the applications 17a, and thus it is possible for the character string to be displayed on the software keyboard 20 to have a content corresponding to the any of the applications 17a.

The MFP 10 may have a configuration in which a character string to be displayed on the software keyboard 20 is made to correspond only to character string correspondence information.

In the MFP 10, a plurality of types of character strings, namely, a title and a message are displayed at different locations on the software keyboard 20, that is, in the title region 21 and the message region 22, respectively, and pieces of character string correspondence information corresponding to these locations, respectively, are at different positions in “kdcattr”, and thus different character strings can be displayed at a plurality of locations on the software keyboard 20.

The MFP 10 may have a configuration in which character strings to be displayed at three or more locations on the software keyboard 20, respectively, are specified on the application 17a side or a configuration in which only a character string to be displayed at one location on the software keyboard 20 is specified on the application 17a side.

In the MFP 10, a character string made to correspond, by the application control part 18b, to character string correspondence information associated with the text box 42 is displayed on the software keyboard 20, compared with a configuration in which a character string itself is included in an HTML document, there is no need to change an HTML interpretation function of the Web browser 18c. Thus, introduction of the MFP 10 can be facilitated.

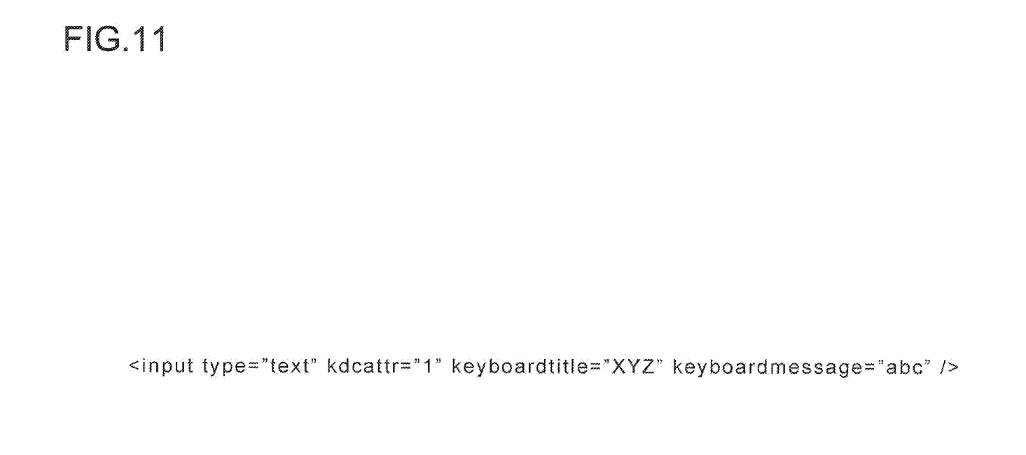

As shown in FIG. 11, the MFP 10 may have a configuration in which a character string itself is included in an HTML document. FIG. 11 is a diagram illustrating one example of a tag, which defines the text box 42, in an HTML document describing the application screen 40. In the tag shown in FIG. 11, for “kdcattr”, only a value for specifying input character word wrap of characters to be inputted into the text box 42 by using the software keyboard 20 is set. As for a title to be displayed in the title region 21 of the software keyboard 20, a character string itself is included as a value of an attribute “keyboardtitle”. Furthermore, as for a message to be displayed in the message region 22 of the software keyboard 20, a character string itself is included as a value of an attribute “keyboardmessage”. Compared with the tag shown in FIG. 8, the tag shown in FIG. 11 includes a character string itself of a title of the software keyboard 20 that is opened from the application screen 40 of any of the applications 17a, and thus it is easy for a developer of the any of the applications 17a to specify a character string of a title of the software keyboard 20.

While the image forming apparatus of the present disclosure is an MFP in this embodiment, there may be used an image forming apparatus of a type other than an MFP, such as a dedicated printer, a dedicated copier, or a dedicated scanner, or an image forming apparatus of a type other than an image forming apparatus, such as a PC (personal computer).

As described above, in the image forming apparatus (MFP 10) of the present disclosure, in a markup command to include a specific display in a screen, each of the applications 17a has a markup document associating the specific display with character string correspondence information, and in a case where the software keyboard 20 is displayed on a display device (display portion 12) in response to an operation inputted to an input device (operation portion 11) with respect to the specific display, a character string corresponding to the character string correspondence information associated with the specific display is displayed on the software keyboard 20. Thus, in a case where the software keyboard 20 is displayed on the display device in response to an operation inputted to the input device with respect to the specific display on the screen of an added one of the applications 17a, a character string corresponding to the specific display can be displayed on the software keyboard 20.

Furthermore, the image forming apparatus (MFP 10) of the present disclosure may have a configuration including a correspondence relationship management unit (application control part 18b) that manages a correspondence relationship between the character string correspondence information and the character string, in which each of the applications 17a makes the correspondence relationship management unit manage the correspondence relationship, the character sting correspondence information is at least part of attribute information indicating an attribute with respect to the specific display, and the keyboard display unit (panel control part 18a) performs control so that, as the character string corresponding to the character string correspondence information associated with the specific display, the character string made to correspond, by the correspondence relationship management unit, to the character string correspondence information is displayed on the software keyboard 20.

By this configuration, in the image forming apparatus (MFP 10) of the present disclosure, compared with a configuration in which a character string itself is included in a markup document, there is no need to change a markup language interpretation function of the Web browser 18c, and thus introduction of the image forming apparatus (MFP 10) can be facilitated.

Furthermore, the image forming apparatus (MFP 10) of the present disclosure may have a configuration in which the correspondence relationship refers to a relationship of correspondence among any of the applications 17a, the character string correspondence information, and the character string, and the keyboard display unit performs control so that the character string made to correspond, by the correspondence relationship management unit, to the any of the applications 17a having the markup document that causes the specific display to be displayed on the display device by the Web browser 18c and the character string correspondence information associated with the specific display is displayed on the software keyboard 20.

By this configuration, in the image forming apparatus (MFP 10) of the present disclosure, the character string to be displayed on the software keyboard 20 is made to correspond not only to the character string correspondence information but also to any of the applications 17a, and thus it is possible for the character string to be displayed on the software keyboard 20 to have a content corresponding to the any of the applications 17a.

Furthermore, the image forming apparatus (MFP 10) of the present disclosure may have a configuration in which the keyboard display unit (panel control part 18a) performs control so that a plurality of types of the character strings are displayed at different locations on the software keyboard 20, and pieces of the character string correspondence information corresponding to the locations, respectively, are at different positions in the attribute information.

By this configuration, in the image forming apparatus (MFP 10) of the present disclosure, different character strings can be displayed at a plurality of locations on the software keyboard 20.

That is, in a method for displaying a software keyboard of the present disclosure, in a case where the software keyboard 20 is displayed on the display device (display portion 12) in response to an operation inputted to the input device (operation portion 11) with respect to the specific display, the character string corresponding to the character string correspondence information associated with the specific display is displayed on the software keyboard 20.

Thus, according to the image forming apparatus and the method for displaying a software keyboard of the present disclosure, in a case where the software keyboard is displayed on the display device in response to an operation inputted to the input device with respect to a specific display on a screen of an added application, a character string corresponding to the specific display can be displayed on the software keyboard.

What is claimed is:

1. An image forming apparatus, comprising:
an input device to which an operation is inputted;
a display device that displays information;
a keyboard display unit that displays a software keyboard on the display device in response to an operation inputted to the input device with respect to a specific display on the display device;
a Web browser that displays on the display device a screen based on a markup document described in a markup language; and
an application that, in a markup command to include the specific display in the screen, has the markup document associating the specific display with character string correspondence information corresponding to a character string to be displayed on the software keyboard,
wherein
in a case where the software keyboard is displayed on the display device in response to an operation inputted to the input device with respect to the specific display, the keyboard display unit performs control so that the character string corresponding to the character string correspondence information associated with the specific display is displayed on the software keyboard.

2. The image forming apparatus according to claim 1, further comprising:
a correspondence relationship management unit that manages a correspondence relationship between the character string correspondence information and the character string,
wherein the application makes the correspondence relationship management unit manage the correspondence relationship,
the character string correspondence information is at least part of attribute information indicating an attribute with respect to the specific display, and
the keyboard display unit performs control so that, as the character string corresponding to the character string correspondence information associated with the specific display, the character string made to correspond, by the correspondence relationship management unit, to the character string correspondence information is displayed on the software keyboard.

3. The image forming apparatus according to claim 2, wherein
the correspondence relationship refers to a relationship of correspondence among the application, the character string correspondence information, and the character string, and
the keyboard display unit performs control so that the character string made to correspond, by the correspondence relationship management unit, to the application having the markup document that causes the specific display to be displayed on the display device by the Web browser and the character string correspondence information associated with the specific display is displayed on the software keyboard.

4. The image forming apparatus according to claim 2, wherein
the keyboard display unit performs control so that a plurality of types of the character strings are displayed at different locations on the software keyboard, and
pieces of the character string correspondence information corresponding to the locations, respectively, are at different positions in the attribute information.

5. The image forming apparatus according to claim 3, wherein
the keyboard display unit performs control so that a plurality of types of the character strings are displayed at different locations on the software keyboard, and
pieces of the character string correspondence information corresponding to the locations, respectively, are at different positions in the attribute information.
